(19) United States
(12) Patent Application Publication
(10) Pub. No.: US 2001/0032732 A1
(43) Pub. Date: Oct. 25, 2001

(54) Coaxial cable improved in transmission characteristic

(75) Inventors: Kazuhiro Fujino, Tokyo (JP); Nobukazu Kato, Tokyo (JP)

Correspondence Address: LAFF, WHITESEL & SARET, LTD, 401 North Michigan Avenue, Chicago, IL, 60611, US

(73) Assignee: Japan Aviation Electronics Industry, Limited

(21) Appl. No.: 09/833,980

(22) Filed: Apr. 12, 2001

(30) Foreign Application Priority Data
Apr. 19, 2000 (JP) 117901/2000

(51) Int. Cl. H01B 7/18

(52) U.S. Cl. 174/106 R

(57) ABSTRACT

In a coaxial cable having a signal conductor and a shield conductor between which a first dielectric member is placed, a second dielectric member covers the shield conductor and said first dielectric member. The second dielectric member has a dielectric constant equal to that of the first dielectric member.

### BACKGROUND OF THE INVENTION

This invention relates to a coaxial cable.

In a digital visual interface, for example, use is made of a transmission minimized differential signaling (TMDS) circuit based on one of digital flat panel standards. The TMDS circuit includes as a transmission cable a single twin-nax cable or two coaxial cables each of which comprises a signal conductor with a drain conductor added thereto.

Traditionally, various types of coaxial cables have been developed and widely used. For example, Japanese Unexamined Patent Publication (JP-A) No. H06-275142 discloses a coaxial cable which comprises a center conductor, a first insulating layer covering the center conductor, a special conductor covering the first insulating layer, and a second insulating layer covering the special conductor. Japanese Unexamined Patent Publication (JP-A) No. S60-101808 discloses a coaxial cable assembly or unit comprising a plurality of coaxial cables each of which is equivalent in structure to that mentioned above and which are collectively accommodated in a tubular member comprising an inner insulator, an outer insulator, and a shield conductor interposed therebetween.

In such a coaxial cable, it is general that an inner one of the insulators is made of a material having a relatively low dielectric constant while an outer one of the insulators is made of a material having a relatively high dielectric constant. Therefore, if the coaxial cable is used in the TMDS circuit, the signal conductor and the drain conductor are not coincident in transmission characteristic with each other.

In a conventional twin-nax cable, the drain conductor comprises a stranded wire which is not subjected to dielectric treatment. Therefore, the signal conductor and the drain conductor are different from each other in inductance, impedance, conductance, and capacitance which dominate or determine EMI characteristics of a high-frequency transmission path. This may results in deterioration in high-frequency transmission path characteristics.

Furthermore, frequency response is also different between the signal conductor and the drain conductor. Therefore, in the strict sense, the drain conductor and the signal conductor will be different in transmission speed from each other.

### SUMMARY OF THE INVENTION

It is therefore an object of this invention to provide a coaxial cable excellent in transmission characteristic.

It is another object of this invention to provide a coaxial cable capable of achieving excellent high-frequency transmission path characteristics.

Other objects of the present invention will become clear as the description proceeds.

According to an aspect of the present invention, there is provided a coaxial cable which comprises a signal conductor, a first dielectric member covering the signal conductor, a shield conductor disposed around the first dielectric member, and a second dielectric member covering the shield conductor and the first dielectric member and having a dielectric constant equal to that of the first dielectric member.

According to another aspect of the present invention, there is provided a coaxial cable which comprises a signal conductor, a first dielectric member covering the signal conductor, a shield conductor disposed around the first dielectric member, a second dielectric member covering the shield conductor and the first dielectric member and having a dielectric constant equal to that of the first dielectric member, a drain conductor extending in parallel to the signal conductor, a third dielectric member covering the drain conductor and having a dielectric constant equal to that of the first dielectric member, an additional conductor extending in parallel to the signal conductor and the drain conductor, and an additional dielectric member covering the additional conductor and having a dielectric constant equal to that of the first dielectric member, the shield conductor covering the first, the third, and the additional dielectric members.

According to still aspect of the present invention, there is provided a coaxial cable which comprises a signal conductor, a first dielectric member covering the signal conductor, a shield conductor disposed around the first dielectric member, a second dielectric member covering the shield conductor and the first dielectric member and having a dielectric constant equal to that of the first dielectric member, a drain conductor interposed between the first dielectric member and the shield conductor, a third dielectric member interposed between the shield conductor and the drain conductor and having a dielectric constant equal to that of the first dielectric member, an additional signal conductor extending in parallel to the signal conductor, an additional dielectric member covering the additional signal conductor and having a dielectric constant equal to that of the first dielectric member, and an additional drain conductor covering the additional dielectric member, the additional dielectric member being interposed also between the additional drain conductor and the shield conductor.

### BRIEF DESCRIPTION OF THE DRAWING

FIG. 1 is a perspective view of an end portion of a coaxial cable according to a first embodiment of this invention;

FIG. 2 is a block diagram of a TMDS circuit in which a driver and a receiver are connected through a cable harness using the coaxial cable illustrated in FIG. 1;

FIG. 3 is an equivalent electric circuit of the cable harness used in FIG. 2;

FIG. 4 is a perspective view of an end portion of a coaxial cable according to a second embodiment of this invention;

FIG. 5 is a cross sectional view of the coaxial cable illustrated in FIG. 4;

FIG. 6 is a perspective view of an end portion of a coaxial cable according to a third embodiment of this invention;

FIG. 7 is a cross sectional view of the coaxial cable illustrated in FIG. 6; and

FIG. 8 is an equivalent electric circuit of the coaxial cable illustrated in FIGS. 6 and 7.

### DESCRIPTION OF THE PREFERRED EMBODIMENTS

Referring to FIG. 1, description will be made of a coaxial cable according to a first embodiment of this invention.

The coaxial cable depicted at 10 comprises a center conductor 11 extending along a center axis, an inner dielectric member 12 covering an outer peripheral surface of the center conductor 11, a mesh-like outer conductor 13 disposed on an outer peripheral surface of the inner dielectric member 12, an outer dielectric member 14 covering an outer peripheral surface of the outer conductor 13, a shield conductor 15 covering the outer dielectric member 14, and an insulating sheath 16 covering an outer peripheral surface of the shield conductor 15. The inner dielectric member 12, the outer dielectric member 14, and the insulating sheath 16 are made of a same dielectric material and have relatively low dielectric constants equal to one another. The shield conductor 15 comprises an aluminum tape wound along an inner surface of the insulating sheath 16.

When the coaxial cable 10 is used, the center conductor 11 serves as a signal conductor for signal transmission. The outer conductor 13 serves as a drain conductor for a signal return path. The inner dielectric member 12 forms a first dielectric member. The insulating sheath 16 forms a second dielectric member. The outer dielectric member 14 forms a third dielectric member.

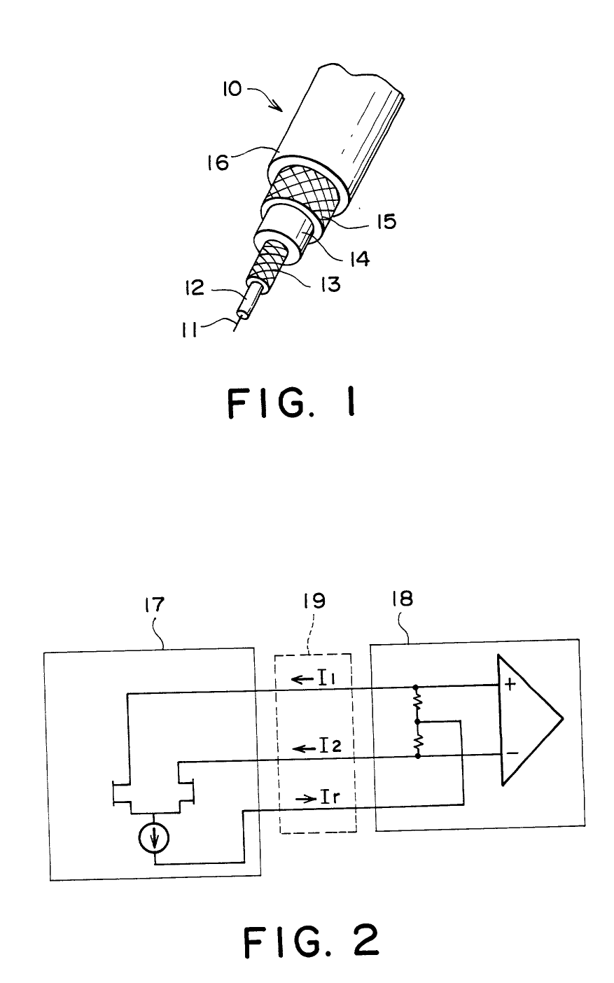

Referring to FIG. 2, the description will be directed to a TMDS circuit based on one of digital flat panel standards known in the art.

The TMDS circuit of FIG. 2 comprises a driver 17, a receiver 18, and a cable harness 19 connecting the driver 17 and the receiver 18. When the TMDS circuit is operated, first and second signal currents 11 and 12 flows from the receiver 18 to the driver 17. On the other hand, a return current Ir flows from the driver 17 to the receiver 18.

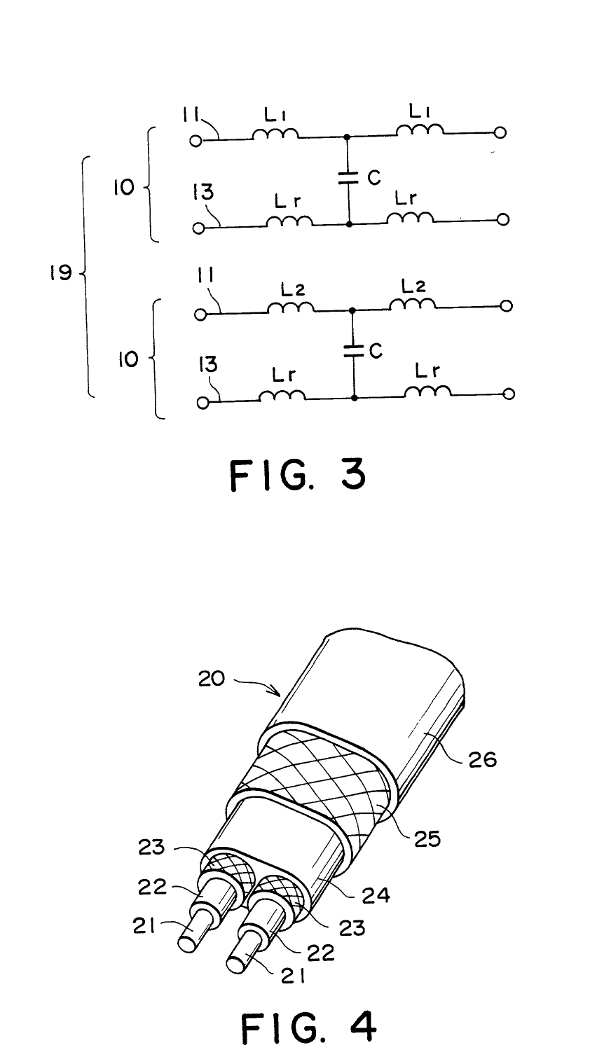

The cable harness 19 comprises two coaxial cables 10 illustrated in FIG. 1. The TMDS circuit having the above-mentioned structure is represented by an equivalent electric circuit illustrated in FIG. 3. Each of the coaxial cables 10 is operable so that a common mode noise is removed in a high-frequency region of 1 GHz or more.

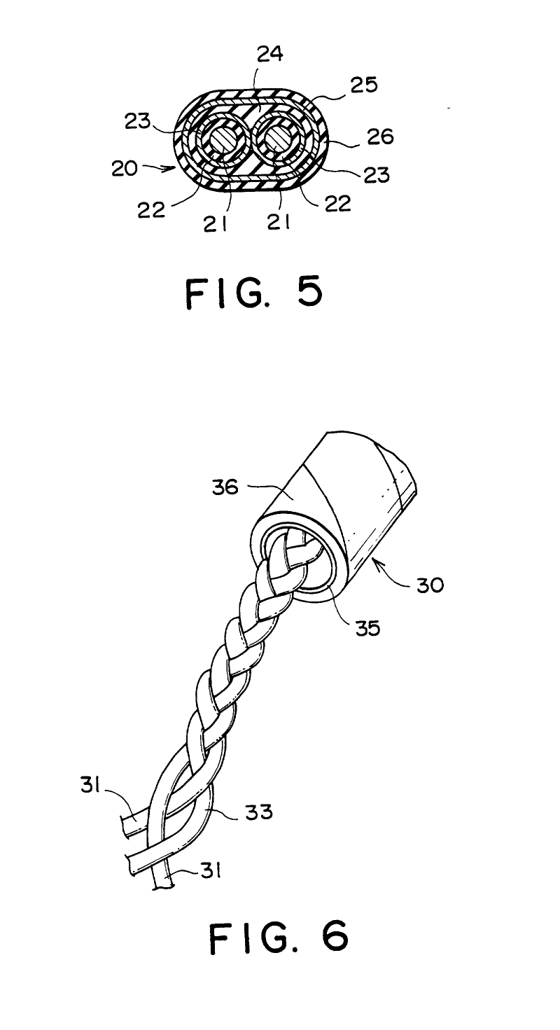

Referring to FIGS. 4 and 5, the description will be made of a coaxial cable according to a second embodiment of this invention.

The coaxial cable depicted by 20 comprises two center conductors 21 extending in parallel to each other in a longitudinal direction of the cable, two inner dielectric members 22 covering outer peripheral surfaces of the center conductors 21, respectively, mesh-like outer conductors 23 disposed on outer peripheral surfaces of the inner dielectric members 22, respectively, an outer dielectric member 24 collectively covering outer peripheral surfaces of the outer conductors 23, a shield conductor 25 covering an outer peripheral surface of the outer dielectric member 24, and an insulating sheath 26 covering an outer peripheral surface of the shield conductor 25. The inner dielectric members 22, the outer dielectric member 24, and the insulating sheath 26 are made of a same dielectric material and have relatively low dielectric constants equal to one another. The shield conductor 25 comprises an aluminum tape wound along an inner surface of the insulating sheath 26.

When the coaxial cable 20 is used, each of the center conductors 21 serves as a signal conductor for signal transmission. Each of the outer conductors 23 serves as a drain conductor for a signal return path. Each of the inner dielectric members 22 serves as a first dielectric member. The insulating sheath 26 forms a second dielectric member. The outer dielectric member 24 forms a third dielectric member.

The coaxial cable illustrated in FIGS. 4 and 5 has the two center conductors 21 and the two outer conductors 23 as described above. Therefore, a cable harness connecting a driver and a receiver of a TMDS circuit can be implemented by a single coaxial cable 20.

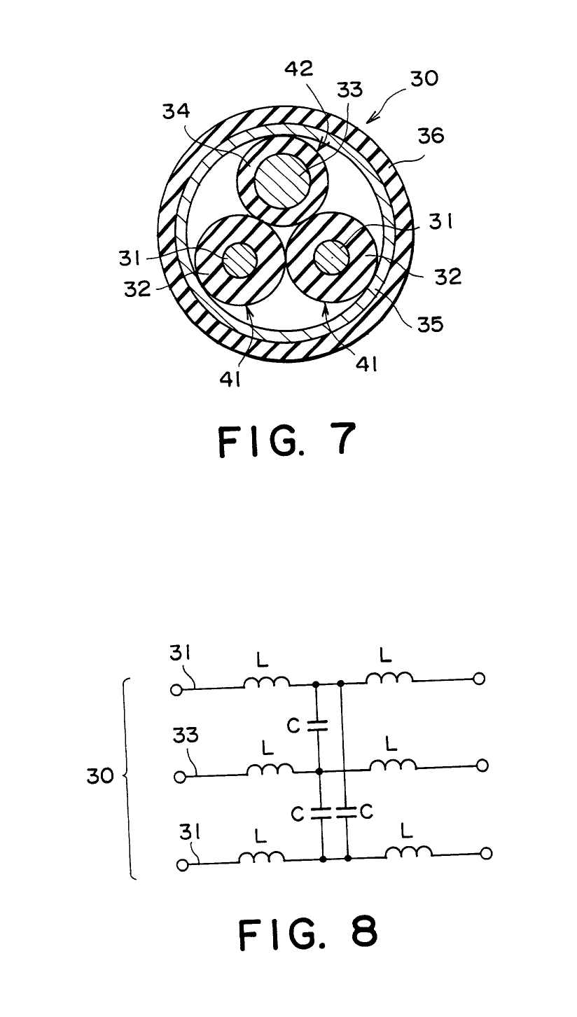

Next referring to FIGS. 6 and 7, description will be made of a coaxial cable according to a third embodiment of this invention.

The coaxial cable depicted at 30 comprises two signal conductors 31, two first dielectric members 32 covering outer peripheral surfaces of the signal conductors 31, respectively, a drain conductor 33, a third dielectric member 34 covering an outer peripheral surface of the drain conductor 33, a shield conductor 35 collectively covering the signal conductors 31 and the drain conductor 33 through the first and the third dielectric members 32 and 34, and an insulating sheath 36 as a second dielectric member covering an outer peripheral surface of the shield conductor 35. Herein, two cables 41 each comprising the signal conductor 31 covered with the first dielectric member 32 and one cable 42 comprising the drain conductor 33 covered with the third dielectric member 34 are braided in three strands. The drain conductor 33 is greater in diameter than the signal conductors 31. Therefore, transmission stress can be reduced.

The first dielectric member 32, the third dielectric member 34, and the insulating sheath 36 are made of a same dielectric material and have relatively low dielectric constants equal to one another. The shield conductor 35 is made of an aluminum Mylar foil shield known in the art. The insulating sheath 36 is made of a polyaluminum tape known in the art. A combination of the shield conductor 35 and the insulating sheath 36 may be made by collectively and helically winding a braided shield tape and a polyvinylchloride tape known in the art. In this event, use can be made as the braided shield tape of that is produced from a tin-plated soft annealed copper wire in the manner known in the art.

The coaxial cable 30 illustrated in FIGS. 6 and 7 can be represented by an equivalent electric circuit illustrated in FIG. 8. The coaxial cable 30 is operable so that a common mode noise is removed in a high-frequency region of 1 GHz or more. The drain conductor 33 is greater in diameter than the signal conductor so that transmission stress can be reduced. As a consequence, transmission characteristics uniform in all of inductance, impedance, conductance, and capacitance are achieved and an attenuation factor is reduced.

What is claimed is:

1. A coaxial cable comprising:
a signal conductor;
a first dielectric member covering said signal conductor;
a shield conductor disposed around said first dielectric member; and
a second dielectric member covering said shield conductor and said first dielectric member and having a dielectric constant equal to that of said first dielectric member.

2. A coaxial cable as claimed in claim 2, further comprising:
a drain conductor extending in parallel to said signal conductor; and
a third dielectric member covering said drain conductor and having a dielectric constant equal to that of said first dielectric member;
said shield conductor covering said first and said third dielectric members.

3. A coaxial cable as claimed in claim 2, wherein said drain conductor is greater in diameter than said signal conductor.

4. A coaxial cable comprising:
a signal conductor;
a first dielectric member covering said signal conductor;
a shield conductor disposed around said first dielectric member;
a second dielectric member covering said shield conductor and said first dielectric member and having a dielectric constant equal to that of said first dielectric member;
a drain conductor extending in parallel to said signal conductor;
a third dielectric member covering said drain conductor and having a dielectric constant equal to that of said first dielectric member;
an additional conductor extending in parallel to said signal conductor and said drain conductor; and
an additional dielectric member covering said additional conductor and having a dielectric constant equal to that of said first dielectric member, said shield conductor covering said first, said third, and said additional dielectric members.

5. A coaxial cable as claimed in claim 1, further comprising:
a drain conductor interposed between said first dielectric member and said shield conductor; and
a third dielectric member interposed between said shield conductor and said drain conductor and having a dielectric constant equal to that of said first dielectric member.

6. A coaxial cable as claimed in claim 5, wherein said signal conductor, said shield conductor, and said drain conductor are arranged to be substantially concentric with one another.

7. A coaxial cable comprising:
a signal conductor;
a first dielectric member covering said signal conductor;
a shield conductor disposed around said first dielectric member;
a second dielectric member covering said shield conductor and said first dielectric member and having a dielectric constant equal to that of said first dielectric member;
a drain conductor interposed between said first dielectric member and said shield conductor;
a third dielectric member interposed between said shield conductor and said drain conductor and having a dielectric constant equal to that of said first dielectric member;
an additional signal conductor extending in parallel to said signal conductor;
an additional dielectric member covering said additional signal conductor and having a dielectric constant equal to that of said first dielectric member; and
an additional drain conductor covering said additional dielectric member, said additional dielectric member being interposed also between said additional drain conductor and said shield conductor.
